(19) United States
(12) Patent Application Publication
(10) Pub. No.: US 2011/0109747 A1
(43) Pub. Date: May 12, 2011

(54) SYSTEM AND METHOD FOR ANNOTATING VIDEO WITH GEOSPATIALLY REFERENCED DATA

(75) Inventors: Curtis Forrester, Cumming, GA (US); Jeffrey Bragg, Marietta, GA (US); Karl Janus, Marietta, GA (US)

(73) Assignee: Siemens Industry, Inc., Alpharetta, GA (US)

(21) Appl. No.: 12/617,308

(22) Filed: Nov. 12, 2009

(51) Int. Cl. H04N 7/18; G09G 5/00; G08B 13/00

(52) U.S. Cl. 348/152; 345/629; 340/541; 348/E07.085

(57) ABSTRACT

A system that annotates video with geospatially referenced data on a display is provided. A video client is connected to a source of video data, the video client being capable of overlaying a video feed from the source of video data with graphics or text data not inherent in the video feed. An annotation provider receives a request for annotation from the video client and returns geographically relevant annotations for display to the video client. A coordinate transformation service device determines a geographic area in view in the video feed and provides accurate position information for security data contained in the video feed into display coordinates. The system may apply geo-spatial information to create a map of a structure in the video feed and to display annotations of locations in the area of field of view that are obstructed by the structure.

### TECHNICAL FIELD

This invention is generally related to a security surveillance system and more particularly, to a security surveillance system capable of aggregating position-specific data collected from multiple sources and incorporating video management capabilities.

### BACKGROUND OF THE INVENTION

A typical security surveillance system may provide a mechanism for viewing recorded or live video in response to a manual user request or as an automatic response to an alarm condition. The video feed displayed may be from a camera known to have a particular location in its field of view or from a camera in some related location to the alarm. Such systems provide protection and security to areas under surveillance.

The video feed may be in close proximity to an alarm or to a particular area of interest. Nevertheless, an unskilled operator of the surveillance system or of the site under surveillance, or a person under stress during a security breach, may not be able to identify important locations or assets in the scene. Thus, the system may not provide optimal protection or security.

### SUMMARY OF THE INVENTION

This invention extends the capabilities of a typical surveillance system by providing a layer of contextual information to a video feed that is specific to the real-world scene. The information is in the form of vector-based and raster-based graphics including text that overlay onto the video, and is derived from a centralized data server capable of transforming the coordinate systems of spatially located security information including physical assets, logical areas, statistical information, sensor events or reported incidents. At the core of the invention is the centralized mechanism for transforming coordinate information from the real-world under surveillance into the 2-dimensional coordinate system of the video feed and providing this information to a video client capable of displaying this information.

The invention makes it possible for any observer to immediately gain timely and relevant information about any location without prior knowledge about said location. The visual synthesis and presentation of data from non-visual data sources leverages innate human capabilities to process large quantities of information in a natural and intuitive fashion.

Other features and benefits of the invention will be evident to one knowledgeable in the field upon review of the included drawings.

In accordance with one aspect of the invention, a surveillance system includes a server, a video source and a video client. The server includes a server processor connected to a source of security information. The video source provides a video signal to the video client. The video client includes a display, a video client processor and a user interface. The video client is connected to the video source. An annotation request is made via the user interface of the video client and transmitted to the server where the server processor searches the source of security information for data relevant to the annotation request to determine one or more relevant annotations which are then combined with the video signal to form a composite annotated signal that is displayed on the display of the video client.

In accordance with another aspect of the present invention, the one or more relevant annotations are sent to the video client by the server and the video client processor combines the one or more relevant annotations with the video signal to form the composite annotated signal.

The annotation request can include a field with information related to an area under surveillance by the video source and wherein the server processor uses the field to search the source of security information for data. By way of example, the field can identify the video source, for example with a camera ID number. Thus, the field identifies the area under surveillance by the video source.

The video source can be a camera providing live video. It can also be a recording device or any other source of video.

In accordance with one aspect of the present invention, the server processor searches the source of security information based on both time and spatial criteria. The time search is performed first to find the most relevant temporal information. Then the information found is searched spatially to locate the information.

There can be one or more additional video sources that are connected to the video client that can be selectively displayed by the video client.

The source of security information can include data from sensors that provide information related to an area under surveillance by the video source. The sensors can include GPS sensors, RADAR sensors, access control sensors, RFID sensors, smart fence sensors and LIDAR sensors.

The source of security information includes data from reports that provide information related to an area under surveillance by the video source. The source of security information can also include data from reports that provide information related to the area under surveillance by the video source. For example, the report can be a police incident report. The database can provide information related to an area under surveillance by the video source.

In accordance with another aspect of the present invention, a workstation that integrates with a surveillance system is provided. The surveillance system includes a server having a server processor connected to a source of security information, and a video source that provides a video signal. The workstation includes a display, a processor and a user interface. The workstation is connected to the server and connected to the video source. The processor provides an annotation request interface via the user interface. When an annotation request is made, the processor transmits the annotation request to the server where the server processor searches the source of security information for data relevant to the annotation request to determine one or more relevant annotations. These annotations are then sent to the processor of the workstation to be combined with the video signal to form a composite annotated signal that is displayed on the display.

In accordance with another aspect of the present invention, a method of surveillance is provided. The steps include displaying a video signal relating to an area under surveillance that is provided by a video source on a display, providing an annotation request interface via a processing system, the processing system forming an annotation request from the annotation request interface and determining annotation information related to the area under surveillance from a security information database based on information in the annotation request, the processing system forming a composite signal from the video signal and the annotation information and displaying the composite signal on the display.

### BRIEF DESCRIPTION OF THE DRAWINGS

FIG. 1 is a block diagram illustrating components of a security surveillance system capable of providing geospatially referenced annotations to a video client in accordance with an aspect of the present invention;

FIG. 2 is a flowchart illustrating a process by which a surveillance system can handle a request to display geographically referenced information in a video client in accordance with another aspect of the present invention;

FIG. 3 is an illustration depicting a video client containing geographically referenced annotations;

FIG. 4 illustrates a database record format; and

FIG. 5 illustrates a menu of a system in accordance with an aspect of the present invention.

### DETAILED DESCRIPTION

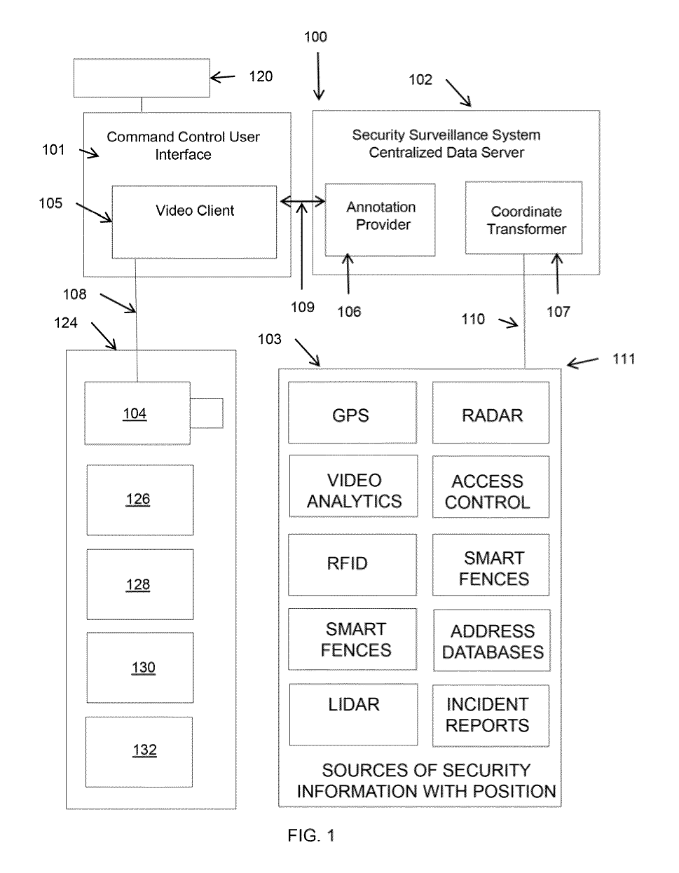

FIG. 1 is a block diagram illustrating components of a security surveillance system 100 in accordance with various aspects of the present invention. The system 100 is capable of providing geospatially referenced annotations to a video client 105. The video client 105 can be a workstation computer that includes a user interface 101 and a display 120. Alternatively, a plurality of displays 120 can be provided at the video client 105. The workstation typically includes a powerful processor and all of the other components normally found in a personal computer.

A digital video feed 108 is provided to the video client 105 by a video source 124. The video source 124 can include a camera 104, video proxy service 126, digital video recorder (DVR) 128, network video recorder (NVR) 130 or video recording apparatus 132. Other sources of video can also be provided to the video client 105. For example, a plurality of cameras 104 may provide a plurality of video feeds to the video client 105.

The display may provide video images generated by a camera for the surveillance of an Area Under Surveillance (AUS). In one embodiment the AUS may be inside a building or a structure. One example of a structure may be a bridge. In a further embodiment, the AUS may be an outside area, which may include a street. In yet a further embodiment the AUS may cover a structure and an area related to the structure. Surveillance image data may be displayed from recorded data or data live from a camera, for instance a camera 104 as shown in FIG. 1.

In accordance with one aspect of the present invention, the video client 105 is connected to a surveillance server 102. The surveillance server 102 is connected to a security data repository 111 which contains a variety of security information. The system 100 is capable of providing geospatially referenced annotations to the video client 105. Video annotation data 109 is provided to the video client 105 by an annotation provider service 106 located in the central data management server 102 of the system 100. A request for annotation information is generally made by a security officer who is sitting at the video client 105. The request can be made for any number of reasons. For example, if the security officer sees something unusual in one of the video feeds from any of the video sources 124, the security officer may want to see additional information relating to the scene being displayed. So, for example, alarms, sensors, comments etc that relate to the scene being viewed could be, and probably would be, helpful to assess the situation. In these cases, the security officer could instruct the video client 105 over a user interface, such as a keyboard, mouse or any other input device, to send a request for available annotation information.

Additionally, automatic requests for annotation information can be made so that annotation data is always displayed when a camera is viewed. In these cases, annotation information is displayed even when no manual annotation request is made. So, for example, whenever a particular camera is viewed, an automatic request for certain annotation information can be made to the server 102. As another example, when a certain type of alarm is received by the video client 105, an automatic request for annotation information can be made that depends on the type of alarm received. The automatic request is configurable so that the type of annotation information requested can be configured in any way to any situation.

Upon request for annotation information 109 from the video client 105, in accordance with one aspect of the present invention, the video client 105 sends the request to a surveillance server 102. The surveillance server 102, in accordance with an aspect of the present invention, has an annotation provider 106 and a coordinate transformer 107, which are applications residing on the server 102 that are called in response to a request for annotation by the video client 105.

When an annotation request is received, the server 102 determines the geographic area in view by querying the coordinate transformation service 107, which in turns queries the security data repository 111 for geospatially referenced security data information 112. The security data repository 111 contains information from a variety of security data providers 103 including GPS units, RADAR systems, video analytics sensors, access control systems, RFID systems, smart fence sensors, address databases, LIDAR systems and emergency or security incident reports provided that these information sources include position information in their native format 110. Information from the security data repository 111 that is related to the geographic area being viewed is selected and provided to the video client 105 so that a composite display signal including both the video from the video source 104 and the annotation from the server 102 is displayed on the display at the video client 105.

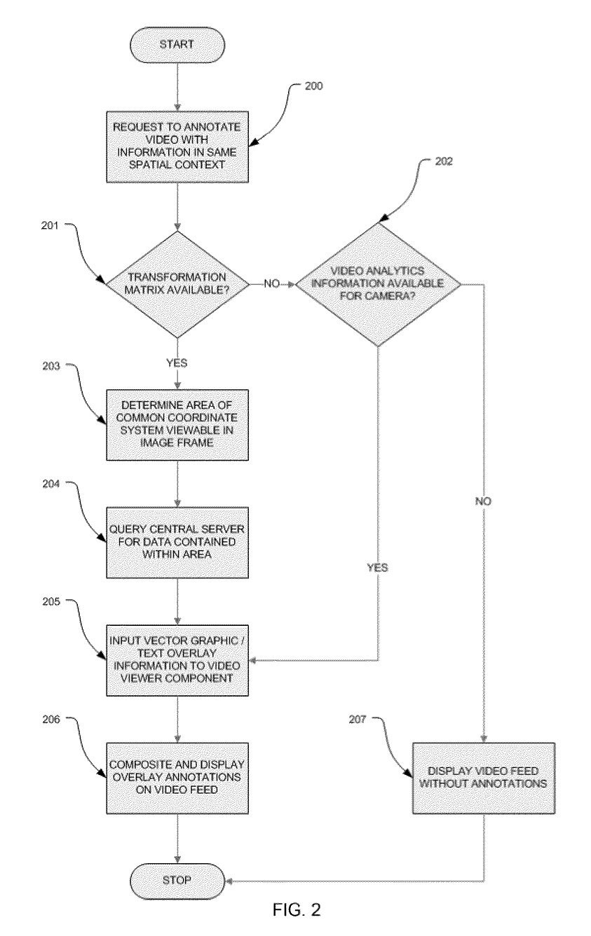

FIG. 2 is a flowchart illustrating the steps followed when a request to annotate video is made from a video client 105 to a surveillance server 102. The request is made in step 200. It is typically made by a security officer at the video client 105 by pressing a key or entering an appropriate command on a user interface to the video client 105.

The security officer requests annotation data for a particular video source. The request for annotation sent in step 200 can include the following information: a request for annotation instruction, the particular video source the request is intended for, and a filter that indicates the type of annotation data requested. This filter can include address information, alarms, access control events, RFID information and other information. Typically, the request does not include the video feed.

After the request is made in step 200, the server 102, in step 201, sends the request to the annotation service 106. The annotation service 106 receives the request from the video client and queries the coordinate transformation service 107. The coordinate transformation service 107, as part of step 201, then determines if a transformation matrix or a transformation service is available for the requested video source.

The availability of the transformation matrix requires sufficient information related to the camera to be provided in the annotation request or to be available at the server 102. If there is enough information to be able to determine the area viewable by a camera, then the transformation matrix will generally be available. So, for example, the parameters about a PTZ camera that are available can be used to generate a bounding-box and frustum for its current state of a camera that defines the area viewable by the camera. Also, an approximation can be made for PTZ cameras where the ranges of the camera can be used to calculate an area of effect for a spatial query and can be used to point the camera at an appropriate location. Conversely, the transformation matrix is considered not available when not enough camera-specific data is available.

The coordinate transformation service 107 uses an ID of the video source 124, which is typically provided with the annotation request, to look up the physical properties of the camera providing the video feed, including the real world location of the camera, its elevation, tilt, roll, and current horizontal and vertical angles of view. Alternatively, the needed camera related information can be provided in the annotation request. If the video feed is not a live camera, then information from another type of video source can be provided. This information is then used to calculate the real world area viewable in the image plane of the camera to determine the transformation matrix.

In accordance with one aspect of the present invention, at a first level, a time-based query, synchronized to the time in view at the video client, is used to limit the scope of the security database that must be searched for spatial data containing a time component. Thus, in accordance with this aspect of the present invention, upon receipt of the annotation request, the annotation service 106 determines the time-based query required to synchronize the annotation data with the video stream. The request contains a time-stamp as well as the time-range pertaining to the video-stream that is to be annotated. The query is used to limit the result set that must be searched for spatial data. If the security data does not have a time-stamp associated with it, it is assumed to be current and will be included in the spatial search (for instance, the location of a building doesn't normally change and is assumed to be current). Then a spatial based query is performed based on the bounding box.

The bounding box containing the viewable area is then intersected with the result set of the initial time-based query to determine which annotations are possible to view. The extent of the time query or bounding box may be increased to some level beyond the visible view to provide the operator with additional annotation information. For instance, if certain details about the AUS are slightly out of view for the particular incident being monitored, the time query or the spatial query can be expanded to obtain additional annotation information.

It is also possible that the real-world bounding-box can be used as an approximation (plus a nominal value to include almost off-screen information) to select appropriate spatial data from the database. The real-world frustum of the camera can be used to clip actually visible objects to the image plane of the camera. The bounding box of the frustum of the camera represents the simplified real-world volume of space that is visible from the camera's point-of-view. The frustum represents the exact (as accurate as the camera parameters) volume of space that is visible from the camera's point-of-view. Neither the bounding box nor the frustum contain information relating to objects blocking the camera's view to other objects (occluders). The time-based query uses the bounding box to quickly determine the set of objects most likely visible from the camera's point-of-view. Once the result set is filtered, the frustum is used to determine exactly which objects in the result set are completely in view, partially in view (clipped), or just out of view (outside the frustum but inside or clipped by the bounding-box). If an object in the query is occluded by another object or scene element, that occluder must also be defined in the database in order to be included in the query. The definition of occluders in the database is used to improve the accuracy of the annotated data.

If a transformation matrix or service is available, then, in step 203, the coordinate transformation service 107 determines the geographic area visible in the image frame of the video feed. Thus, the coordinate transformation service determines the area of the common coordinate system that is viewable in the image frame.

Then, in step 204, this area is used to query the security data repository 111 for information located in the geographic area visible in the image frame of the video feed. This query can include a search of all available information in the security data repository so that all sources are searched, including GPS sources, RADAR sources, access control sources, video analytics, RFID's, smart fences, address databases, LIDAR sources, incident reports, other sensors and other source. Alternatively, a subset of these sources can also be searched. So, for example, the request for annotated data can include a request for a type of annotated data and the search performed in step 204 could be limited to the sources that include the type of annotated data requested.

Security data records in the repository 111 preferably contain four dimensions of information, including three dimensions of space and one dimension of time. In accordance with one aspect of the present invention, the query of the repository 111 determines the most time appropriate data. This can be based upon whether an operator is watching live or recorded video. The most up-to-date data for the video is preferably determined using a time based query and then a spatial query is performed on the result set. For some types of data, such as physical address data, the time value is presumed to be “current” all the time. For data of a more ephemeral type (such as security events), the most current data less than or equal to the time in view in the video source within a bounding margin, which could be definable in the annotation request, is displayed. The data is stored in the data repository 111 in multiple tables appropriate to the source and type of data. For example, address data may be stored in an address table. Video analytics data may be stored in an “alarm” or “object” table. In a preferred implementation, a parent table may include the most current or “final” spacetime coordinates for every object in the security data repository and child tables for address data, video analytics data, access control data, etc. may be referenced using the primary key of the parent table. Of course, other types of queries can be used. For example, a spatial query alone could be used.

This query is performed by coordinate transformer 107 in the server 102.

In step 205, the result of the query is then converted 206 to vector graphic and/or raster graphic including text in the form of an overlay information to be presented to the video client 105. This step is preferably performed by the server 102. In another aspect of the present invention, other video formats, such as raster graphics, can also be used.

In step 206, the annotated information is transmitted from the server 102 to the video client 105. The video client 105 then forms a composite signal from the source (or sources) of video 104 and the annotated information from the server 102. The video client 105 then displays the composite video and annotated data signal on its one or more displays 120.

If, in step 201, it is determined that a transformation matrix is not available for the selected video feed, then in step 202, the transformation service 107 searches the security information repository 111 to determine if video analytics information is available specific to the video feed. Video analytics information is data that is related to the camera and may include an ID number and a displayed time keeper. The video analytics information may already be generated in the appropriate screen coordinates. In these cases no coordinate transformation or spatial lookup is required since the video source is known and the data to be used for annotation is already described in the coordinate system of the screen.

If available, in step 207, the video analytics information is provided to the video client 105 as vector overlay information for presentation on the video feed, as described before. The video analytics may also be provided and inserted as raster graphics.

Finally, if no annotation information of any kind is available, the video feed is presented 208 without annotation.

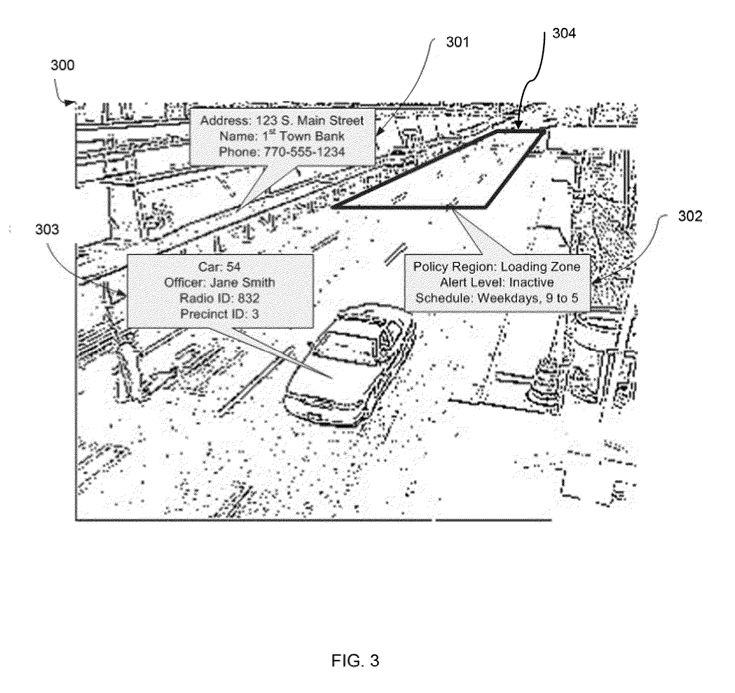

FIG. 3 illustrates a display at the video client 105 displaying geographically referenced annotations that have been integrated with a video feed in accordance with the previous description. FIG. 3 illustrates what a user could expect to see after requesting annotations for the scene 300.

Annotations may consist of address data 301 that appears in an annotation box referencing a specific ground coordinate. Annotations may also consist of resource data 303 of mobile objects such as for instance a patrol car equipped with GPS transponders or some other location determining device, which may be a mobile device. Such devices, which may include temperature, intrusion, smoke, light and location sensing devices may all be called sensors. The annotation 303 illustrated in FIG. 3 originated in the GPS source in the security data repository 111. In accordance with the annotation request from the video client 105, the server 102 searched the repository 111 with the coordinates of the viewing area shown in FIG. 3 in mind and found the GPS information in the repository 111 associated with the illustrated police car. The available information is shown as car 54, officer smith, radio id 932 and precinct 3. Other information can also be shown. For example, the speed of the car can be calculated from the GPS information and displayed.

A wide variety of annotations can be displayed. Vector graphics 304 in the form of poly-lines, circles and ellipses may also appear as annotations with or without text annotations describing the vector graphic. In this example graphics 304, which may also be raster graphics, identifies a space on a street. The displayed graphics identify the use of the specific area 304 as a loading zone that can be used weekdays from 9 to 5, but is currently inactive. The data required to generate these annotations can be retrieved based on a query that requests data related to an Area Under Surveillance which covers the specific area in accordance with the previous descriptions.

Other annotations can be shown. For example, annotation 301 in FIG. 3 shows information relating to a building. In this case, it shows the occupant of the building as 1^{st} Town Bank, the phone number of the bank and the address of the building.

All annotations may be enabled or disabled by source type and transparency and color settings may be adjusted to increase or decrease the visibility of the annotations.

As one aspect of the present invention, a lens of a camera is provided with a 3D-to-2D mapping of its AUS or part of its AUS, which is generally a three dimensional environment to a two dimensional projection environment on a display. For instance during a calibration step, geo-spatial coordinates (longitude, latitude and height) are associated with one or more landmarks in a field-of-view of a camera. The geo-spatial coordinates of the camera are also determined and recorded, including the azimuth of the direction that the lens is pointing and the inclination of the camera lens compared to a calibration plane (for instance the surface of the earth). Based on the position and orientation of the camera, and using landmarks in a field-of-view of the camera one may create a 3D-to-2D mapping that maps the AUS points in the field-of-view of the camera to a 2D plane, which is the screen plane.

In a further embodiment one may apply a lens model to the 3D-to-2D mapping to account for different zoom factors of the lens. In yet a further embodiment, one may define a visibility AUS, wherein obstructions such as buildings, walls, dense growth of bushes are identified with geo-spatial coordinates, so that an AUS is substantially displayed as a 3D map on a 2D screen.

In yet a further embodiment the 3D-to-2D mapping may be associated with a PTZ camera (pan-tilt-zoom). A surveillance camera may cover an AUS that is for at least part of the surveillance out of the field-of-view of the camera. The camera may pan and tilt in a regular pattern to cover a certain part of an AUS for at least part of the time. A PTZ camera may be part of a system that can track an object or a person. A PTZ camera may also be remotely controlled to be pointed at an area of interest within the AUS and for instance zoomed-in on. One may create a 3D-to-2D mapping that adjusts for the status of pan, tilt and zoom of the camera. One may associate a specific mapping, and specific visibility areas with a specific pan, tilt and zoom setting of a camera and store such settings in a computer readable memory. A certain PTZ setting of a camera may then automatically cause to retrieve a specific 3D-to-2D mapping.

A coordinate transformer 107 in one embodiment of the present invention is related to a specific camera in a specific environment. It may be implemented in the central data management component 102, which may be a database server. The coordinate transformer may be trained using pre-identified landmarks and by identifying visibility areas in a calibration step. A coordinate transformer that is trained on visibility areas may assign to positions in the AUS that would not be visible to the camera on a 2D screen a special identification. Such a special identification may be used to not show on a display screen any information related to a not visible position. The special identification may also be used to display on a screen in a distinguishing manner from other information, information related to a position that is not visible to the camera. For instance, information related to not visible positions may be displayed in a special color, or in a more transparent color than other information. One may also use the special identification to only show information related to a position that is not visible to the camera.

In one embodiment one may create a 3D model or map of buildings and structures in the AUS, for instance by using a LIDAR system. Such a 3D map may be provided with geospatial coordinates of a plurality of landmarks of the AUS. One may then create a 3D-to-2D coordinate transform by first creating a view of the 3D map of the AUS by applying the geo-spatial position of the camera, and then by mapping of coordinates in 3D to 2D screen coordinates. The coordinate mapping in a further embodiment includes structure coordinates, as well as coordinates in open space, such as roads. The creation of 3D environmental maps is known and is disclosed for instance in . . . .

In yet a further embodiment one may combine video images of an AUS with computer images. For instance one may have a video of an AUS that is combined or overlaid with a 3D map. Such an overlaid or combined image may then be displayed on a 2D screen after a 3D-to-2D coordinate transformation. The 3D map or image may be generated in for instance the Video Client 105 rather than in the server 102. One may also apply a dedicated coordinate transformer server that may or may not be performing other services. The combining of computer generated images, such as a transformed 3D map with a video is known as Augmented Reality Video (ARV). Augmented Reality Video is for instance used in generating the well known “first-down” line in video images of a football game.

A Coordinate Transformer may store a transformation map in a memory. It may retrieve a transformation map based on a setting of a camera and apply the coordinate transformation on an image on the display screen based on a setting of a camera. A camera may be set in a fixed position, in which case only one coordinate transformation is applied. A Coordinate Transformation may be implemented as a mathematical transformation by using a transformation matrix. A transformation may be performed by applying the matrix. In one embodiment one may have a display such as a screen that shows an image of an AUS which may be enhanced with overlaying graphics. An object may appear in the AUS which has known 3D geo-spatial coordinates. One may determine a 3D-to-2D transformation of the coordinates by retrieving the transformation map from a memory. For instance 3D coordinates may form an address which has a content that is the corresponding 2D address. One may only provide a partial transformational map that is stored. Determining of 2D coordinates may then involve calculations which may include interpolations of coordinates. One may also directly calculate 2D coordinates by applying the 3D coordinates to a transformation matrix.

The Annotation Provider 106 requires data to be annotated into the video display or video client 105. The data may be available in a Security Data Repository 111. The data repository 111 may be updated on a regular basis. The data repository may also query other sources for recent information through an update request. Such a query may limit searched data to be only data that has attached to it geo-spatial location information. It may provide further initial limitations to collect data that has a high level of urgency, such as recent sensor data, for instance from a fire sensor or an intrusion sensor. Other limitations may be required to make sure that the system is not overwhelmed during an emergency with too much updates that may also be not relevant.

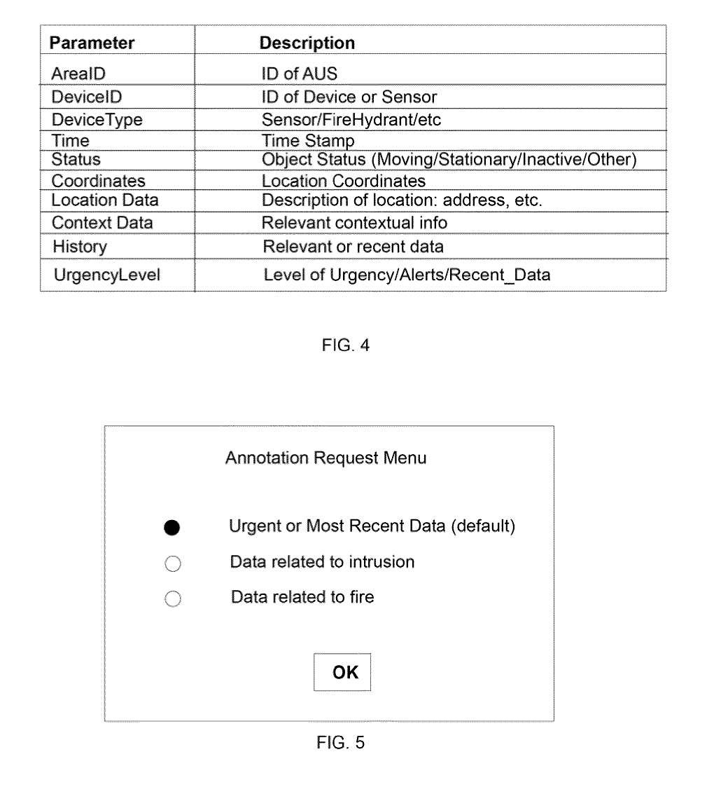

In order to better discriminate between data, one may store the data in the repository according to a preferred format, wherein a device or sensor or location is provided with a record format. An illustrative example of such a record format is provided in FIG. 4. A record may be associated with a sensor device such as a smoke detector or an intrusion detector. When a device is installed in a location, its properties may be entered into a database that contains all relevant static information, including its geo-spatial data. In a further embodiment, the device may be provided with for instance a GPS device that will attach geo-spatial data to any update of its data to a receiving station. The receiving station may store all data in accordance with a preferred record format such as shown in FIG. 4. It may be the case that data related to a sensor may have its own native format. A database application related to the data repository may have a translation program that translates the sensor or device data into the required format of the repository. The application may also translate the format of the repository into the native format of local databases to be queried for updates.

While installed sensors and cameras in the AUS are likely candidates for devices that are registered in the repository, one may not limit the repository to storage of these devices only. One may provide also data of structures and locations that may be of importance. For instance in case of a fire alert one may annotate the location of a fire hydrant in the AUS. One may provide information if a hydrant is out of service. One may identify locations of valves, such as for gas. One may also annotate locations of particular interest, such as a storage place of flammable materials, with perhaps information on the nature of the stored materials. In many cases it would be helpful to know the owner of a structure or building or a person that may be contacted. In case of a fire it could be helpful to know of fire code violations in a building to allow precautions before entering. These and other useful data sources are fully contemplated of being available and made available to the system as disclosed herein.

Clearly, one may have much more data available for display in an annotated display than is required or useful. In one embodiment one may limit the display of annotated data by default to the most useful and urgent data. For instance, a sensor in an AUS may be triggered and may generate an alert. Such an alert may generate an automatic request for annotation in a display and may trigger the Coordinate Transformer to provide the 2D position of the sensor on the screen that is part of the video client. The Annotation provider may extract from the data provided by the Data Repository the data that has to be displayed on the screen. The Annotation Provider may attach the location on the screen of the annotation and calculate the amount of space required on the screen to display the relevant data and may provide additional display properties such as a specific alert color and/or text size and/or a requirement for an audio alert to accompany the annotation. It may then provide all data to the video client, which will display the annotation in the video display on the screen. One flow of steps in the annotation process is provided in FIG. 2 and will be further discussed in detail further below.

In one embodiment, a person monitoring a surveillance system may want to have an update on the status of the sensors in a certain area of the AUS. Such an update may be due to an alert, for instance by a phone call. An update may also be requested because video shows activities that require closer inspection. In one embodiment such an annotated update may be achieved by clicking on a displayed area of the AUS on a screen. One may also draw a box over a certain area on the screen. Such an action by a user then initiates a sequence of video annotation. The video annotation may be limited to sensors and devices that are located within a building or an area falling within the activated area of the screen. When the system applies ARV the system may annotate only sensors, devices and locations that are visible from the point of view of the camera or that are related to a visible area or structure, for instance in areas directly behind or near visible obstacles such as walls that obstruct direct view of such areas.

In a further embodiment, one may call up menus, which may be context sensitive, to drill down on the details of an area or structure. An illustrative example of a menu is provided in FIG. 5. A user may call up a menu that shows for instance three choices: a first choice is to provide an update with most recent data. Such a choice may be the default choice. A second choice may be to annotate data related to a potential fire. This may include data related to any fire related sensor in the selected area. It may also include the location of working fire hydrants in the direct vicinity. It may include fire-code violations of a structure. It may also provide further options. For instance, it may be that an entrance, a hallway, or back-side of a building has an active surveillance camera. An annotation may provide information related to such a camera. If the camera is active, an authorized user may click on for instance a camera annotation on a screen to activate video of the camera in a separate window or on a separate screen.

An annotation may provide a fire alert in a building. The annotation may provide a name and phone number of a person living in an apartment that has the smoke sensor located in it. This may allow a person who is monitoring the system to contact the person by phone.

A server and a client may be part of a security system. Servers and clients mentioned herein are computing devices which contain at least a processor which may be programmable or which may have a preset and fixed instruction set; a memory to store data, which may be instruction data; the data may be accessed by the processor; mass storage to store semi-permanently data; an input port to receive data and an output port to provide data. A port may be connected to a network, or it may be connected to a device. A network may be a wired network or a wireless network. A client and/or a server may be connected to a display to display an image. A display may be a video screen. A client, such as a video client may be a mobile computing device that connects to sources or to a security network. In a further embodiment a video client may connect to a security network via the Internet. In yet a further embodiment, a video client may be a mobile device that connects to a security network. While the invention is described in a client-server context, it can also be implemented in a standalone computing device as well.

In general, one wants to display annotations of sensors, structures and the like that are within view of the camera and that are displayed on a display. However, in some cases a relevant sensor, structure or annotated event may take place outside the area that is visible on the display. In that case the system may generate an annotation at the edge of the screen for instance in a special color or font that indicates that relevant data from outside the field of view is available. The system may provide an annotation alert in the shape of an icon that can be clicked upon to display further details. In a further embodiment such an alert may cause for instance a panning or tilting or zooming out of an area of a camera to capture the area within the field of vision of the camera. Clicking on an edge annotation may also switch to another camera that will capture the area of edge annotation inside its field of vision.

U.S. Pat. No. 7,236,176 entitled “SURVEILLANCE MANAGEMENT SYSTEM” issued on Jun. 26, 2007, is hereby incorporated herein by reference in its entirety. U.S. Pat. No. 7,295,106 and U.S. patent application Ser. No. 10/676,395 are both hereby incorporated by reference in their entirety.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A surveillance system, comprising:
a server comprising a server processor connected to a source of security information;
a video source providing a video signal; and
a video client comprising a display, a video client processor and an user interface, the video client being connected to the server and connected to the video source;
wherein an annotation request is made via the user interface of the video client and transmitted to the server where the server processor searches the source of security information for data relevant to the annotation request to determine one or more relevant annotations which are then combined with the video signal to form a composite annotated signal that is displayed on the display of the video client.

2. The surveillance system of claim 1, wherein the one or more relevant annotations are sent to the video client by the server and the video client processor combines the one or more relevant annotations with the video signal to form the composite annotated signal.

3. The surveillance system of claim 1, wherein the annotation request includes a field with information related to an area under surveillance by the video source and wherein the server processor uses the field to search the source of security information for data.

4. The surveillance system of claim 3, wherein the field identifies the video source.

5. The surveillance system of claim 3, wherein the field identifies the area under surveillance by the video source.

6. The surveillance system of claim 1, wherein the video source is a camera providing live video.

7. The surveillance system of claim 1, wherein the server processor searches the source of security information based on time and spatial criteria.

8. The surveillance system of claim 1, further comprising one or more additional video sources that are connected to the video client that can be selectively displayed by the video client.

9. The surveillance system of claim 1, wherein the source of security information includes data from sensors that provide information related to an area under surveillance by the video source.

10. The surveillance system of claim 9, wherein the sensors include GPS sensors, RADAR sensors, access control sensors, RFID sensors, smart fence sensors and LIDAR sensors.

11. The surveillance system of claim 1, wherein the source of security information includes data from reports that provide information related to an area under surveillance by the video source.

12. The surveillance system of claim 9, wherein the source of security information includes data from reports that provide information related to the area under surveillance by the video source.

13. The surveillance system of claim 11, wherein the report is a police incident report.

14. The surveillance system of claim 1, wherein the source of security information includes information from address databases that provide information related to an area under surveillance by the video source.

15. A workstation that integrates with surveillance system having a server comprising a server processor connected to a source of security information, a video source providing a video signal, comprising:
a display;
a processor;
an user interface,
wherein the workstation is connected to the server and connected to the video source; and
wherein the processor provides an annotation request interface via the user interface and when an annotation request is made, the processor transmits the annotation request to the server where the server processor searches the source of security information for data relevant to the annotation request to determine one or more relevant annotations which are then sent to the processor of the workstation to be combined with the video signal to form a composite annotated signal that is displayed on the display.

16. The workstation of claim 1, wherein the annotation request includes a field with information related to an area under surveillance by the video source and wherein the server processor uses the field to search the source of security information for data.

17. The workstation of claim 16, wherein the field identifies the video source.

18. The workstation of claim 16, wherein the field identifies the area under surveillance by the video source.

19. The workstation of claim 1, wherein the video source is a camera providing live video.

20. The workstation of claim 15, further comprising one or more additional video sources.

21. The workstation of claim 15, wherein the source of security information includes data from sensors that provide information related to an area under surveillance by the video source, data from reports that provide information related to an area under surveillance by the video source and information from address databases that provide information related to an area under surveillance by the video source.

22. The workstation of claim 21, wherein the sensors include GPS sensors, RADAR sensors, access control sensors, RFID sensors, smart fence sensors and LIDAR sensors.

23. A method of surveillance, comprising:
displaying a video signal relating to an area under surveillance that is provided by a video source on a display;
providing an annotation request interface via a processing system;
the processing system forming an annotation request from the annotation request interface and determining annotation information related to the area under surveillance from a security information database based on information in the annotation request;
the processing system forming a composite signal from the video signal and the annotation information; and
displaying the composite signal on the display.
